(19) United States
(12) Patent Application Publication
(10) Pub. No.: US 2010/0055018 A1
(43) Pub. Date: Mar. 4, 2010

(54) METHOD FOR PRODUCING PYROGENE-FREE CALCIUM PHOSPHATE

(75) Inventor: Marc Bohner, Grenchen (CH)

Correspondence Address: RANKIN, HILL & CLARK LLP, 38210 Glenn Avenue, WILLOUGHBY, OH, 44094-7808, US

(73) Assignee: DR. H.C. ROBERT MATHYS STIFTUNG, Bettlach (CH)

(21) Appl. No.: 12/595,389

(22) PCT Filed: Apr. 13, 2007
(86) PCT No.: PCT/CH07/00181

§ 371 Date: Oct. 9, 2009

(51) Int. Cl. C01B 25/32

(52) U.S. Cl. 423/308; 977/773

(57) ABSTRACT

The method relates to the production of essentially pyrogene-free calcium phosphate starting from one or more calcium phosphate educts having a Ca/P molar ratio in the range of 1.00 to 2.00 and being formed in a pre-determined shape which remains essentially the same during the following procedural steps: A) transforming said educt(s) at least partly to beta-tricalcium phosphate (α-TCP), alpha-tricalcium phosphate (α-TCP), tetracalciumphosphate.(TetCP) or a mixture thereof at a temperature above 600° C.; B) cooling down the material obtained in step A with said β-TCP, α-TCP, TetCP or a mixture thereof to below 600° C.; C) reacting the material obtained in step B with said β-TCP, α-TCP, TetCP or a mixture thereof with water in gas or liquid phase or in an aqueous Solution at a temperature above room temperature to obtain an end-product which is essentially pyrogene-free. The pyrogene-free calcium phosphate obtained as an end-product by the method according to the invention can be advantageously used as a bone fixation or bone replacement implant or as a surface layer for a bone fixation or bone replacement implant.

### FIELD OF THE INVENTION

The invention relates to a method for producing pyrogene-free calcium phosphate starting from one or more calcium phosphate educts having a Ca/P molar ratio in the range of 1.00 to 2.00 and being formed in a pre-determined shape which remains essentially the same during the whole production method.

Pyrogens are substances capable of increasing the body temperature of humans and which may induce fever and may be used for fever therapy. Pyrogens may be of microbial origin (they are often polysaccharides) and they may also contaminate distilled water.

A special class of pyrogens are endotoxins. Endotoxins are toxins closely associated with the living cytoplasm or cell wall of certain microorganisms, which do not readily diffuse into the culture medium, but are released upon lysis of the cells. Endotoxins are potentially toxic, natural compounds found inside pathogens such as bacteria.

In the production of calcium phosphates any contact to an atmosphere in which micro-organisms are present leads to calcium phosphates containing pyrogens. Incubating a calcium phosphate sample in an aqueous solution is particularly “dangerous” because micro-organisms can easily proliferate.

A too high pyrogen content can lead to biocompatibility problems after implanting calcium phosphate materials in the host (e.g. human patient). Therefore, standards exist that describe the pyrogen content that an implant may contain. As the method used to determine the pyrogen content is based on an animal experiment (with rabbits) and as the method to quantify the endotoxin content is cell-based and much more reliable (LAL test), pyrogenicity is generally assessed by measuring the endotoxin content. The FDA guidelines (Guidance for Industry 1997 FDA, Guideline on Validation of the Limulus Amebocyte Lysate Test as an End-Product Endotoxin Text for Human and Animal Parenteral Drugs, Biological Products, and Medical Devices (December 1987).) mention a limit of 20 endotoxin units (EU) respectively 2.4 EU per implant.

### DESCRIPTION OF THE PRIOR ART

Most synthetic calcium phosphate materials obtained by aqueous processes present the disadvantage that crystal growth of the calcium phosphates or subsequent treatments are performed at a temperature at which micro-organisms can proliferate. As removal of micro-organisms is very difficult, these materials are not useful for implantation into the patient's body.

Furthermore some known calcium phosphate materials do contain proteins (e.g. bovine serum albumin) which prohibits their use as implant material for humans (immunological reactions). The possible purification of such material would be extremely costly and therefore is not viable. Moreover, the sterilization of a composite polymer(protein)/ceramic material is extremely difficult.

### SUMMARY OF THE INVENTION

It is an object of the invention to provide a method for producing pyrogene-free calcium phosphate which allows using it as a bone fixation or bone replacement implant or as a surface layer for a bone fixation or bone replacement implant.

For the better understanding of the various compounds mentioned below a list of abbreviations is given as follows:

α-tricalcium phosphate [Ca₃(PO₄)₂] α-TCP

β-tricalcium phosphate [Ca₃(PO₄)₂] β-TCP

Brushite (mineral name of DCPD) DCPD

Calcium pyrophosphate (Ca₂P₂O₇) CPP

Dicalcium phosphate (CaHPO₄) DCP

Dicalcium phosphate dihydrate (CaHPO₄.2H₂O) DCPD

Calcium-deficient hydroxyapatite [Cag(HPO₄)(PO₄)₅OH] CDHA

Hydroxyapatite [Ca₁₀(PO₄)₆(OH)₂] HA

Monetite (Mineral name of DCP) DCP

Octocalcium phosphate [Ca₈H₂(PO₄)₆.5H₂O] OCP

Tricalcium phosphate (=CDHA) TCP

Tetracalcium phosphate [Ca₄(PO₄)₂O] TetCP

amorphous calcium phosphate ACP

The method according to the invention starts from one or more calcium phosphate educts having a Ca/P molar ratio in the range of 1.00 to 2.00 and being formed in a pre-determined shape which remains essentially the same during the following procedural steps:

A) transforming said educt(s) at least partly to beta-tricalcium phosphate (β-TCP), alpha-tricalcium phosphate (α-TCP), tetracalcium phosphate.(TetCP) or a mixture thereof at a temperature above 600° C.;

B) cooling down the material obtained in step A with said (β-TCP, α-TCP, TetCP or a mixture thereof to below 600° C.;

C) reacting the material obtained in step B with said β-TCP, α-TCP, TetCP or a mixture thereof with water in gas or liquid phase or in an aqueous solution at a temperature above room temperature to obtain an end-product which is essentially pyrogene-free.

An advantage of the method according to the invention is the pre-determined shape of the educts which remains essentially the same during the whole production method. If the shape would be given only after incubation (Step C), a lot of wear particles would be created which cannot be so easily removed. Moreover, the whole procedure would have to be performed under clean (aseptic) conditions to prevent the presence of micro-organisms or in conditions in which micro-organism proliferation does not occur (=high temperature) which is not easy as manual operations have to be performed. The latter is also valid if the shape would be given during incubation (step B). When shape is given according to a special embodiment of the invention before incubation, precautions have also to be taken to prevent the presence or proliferation of micro-organisms, but since there is practically no manual operation to perform, this approach is technically much easier.

The calcination in step A of the method according to the invention has two desirable effects: the first is that it burns all organics, e.g. micro-organisms; the second is that sintering strengthens the materials.

The temperature of step B should be superior to room temperature, preferably superior to 40° C. In a special embodiment said temperature of step B is superior to 50° C., preferably superior to 60° C.

If the intermediate products obtained in said step B are stored for some time before continuing with step C this should purposefully be done at a relative humidity of maximum 20%, preferably maximum 10%. When starting with step C the intermediate products obtained in step B should purposefully be brought above room temperature, preferably above 40° C. In a special embodiment the temperature when starting with step C is brought above 50° C., preferably above 60° C.

In a special embodiment of the invention the beta-TCP, alpha-TCP, TetCP or a mixture thereof obtained in step A is directly cooled down without prior mechanical treatment, like milling or grinding.

Purposefully said pyrogene-free calcium phosphate has a content of endotoxin units (EU) lower than 1 EU/g, preferably lower than 0.01 EU/g.

In a special embodiment step C is performed at a pressure larger than 1 atm, the advantage being that the vapor phase is saturated in water.

Purposefully the end-product obtained in step C has a minimum content of pyrogene-free calcium phosphate of more than 20 weight-percent, preferably more than 50 weight-percent. Said reaction of step C can be performed at a temperature above 80° C., preferably above 100° C. This relatively high temperature prevents bacterial growth but keeps the shape of the granules or blocks of the calcium phosphate.

In a special embodiment the aqueous solution of step C is diluted carbonic acid in order to obtain carbonated apatite. The aqueous solution of step C may alternatively be a sodium fluoride solution in order to obtain fluoroapatite.

Purposefully said educt(s) are shaped in the form of a granular or open-macroporous block. The single granules of said granular block may have a dimension larger than 50 microns, preferably larger than 100 microns. The single granules of said granular block may have a minimum apparent volume of 50'000 microns³ , preferably of 100'000 microns³. The single granules of said granular block may have a minimum weight of 0.04 micrograms, preferably of 0.10 micrograms.

Said educts may be pre-shaped either by by slip-casting, granulation techniques, emulsification, grinding, 3D printing or a combination of thee processes. The pre-shaping can be done also by pressing. This pre-shaping allows obtaining a pyrogene-free granular block or macroporous block out of a calcium phosphate with a high specific surface area.

Said calcium phosphate educts belong preferably to the group of DCP, DCPD, α-TCP, β-TCP, CDHA, apatite, hydroxyapatite, ACP, OCP and TetCP.

Said calcium phosphate educts may further contain one or more source of ions such as C, Cl, F. Li, K, Mg Na, S, Si, Sr preferably in an amount of less than 2 weight-%. Typically said ions are present in an amount of less than 0.2 weight-%, preferably less than 0.01 weight-%,

The water used in the method according to the invention may be bi-distilled and/or sterile water. The water should preferably be essentially pyrogene-free.

The gas phase should purposefully have a relative humidity of at least 80%, preferably at least 90%. In a special embodiment the gas phase has a relative humidity of 100%.

The temperature of over 1120° C. of step A should be kept for at least 1 minute, preferably at least 10 minutes. Typically it is kept of 1 hour.

The cooling rate in step B should be larger than 1° C./min, preferably larger than 10° C./min. Typically the cooling is performed in the temperature range of 1100° C. down to at least 700° C.

The temperature in step B is purposefully lowered to less than 200 ° C., preferably less than 100° C.

In a special embodiment said educt(s) have a Ca/P molar ratio higher than 1.35, preferably higher than 1.45. Said educt(s) may have a Ca/P molar ratio lower than 1.70, preferably lower than 1.60

In a further embodiment said end-product has a Ca/P molar ratio higher than 1.0, preferably higher than 1.2. Said end-product may have a Ca/P molar ratio lower than 2.0, preferably lower than 1.8. Preferably said end-product has a Ca/P molar ratio between 1.45 and 1.53.

The temperature of step A is purposefully above 700° C., preferably above 800° C. In a special embodiment the temperature of step A is above 900° C., preferably above 1000° C. In a further embodiment the temperature of step A is above 1120° C. transition temperature of alpha-TCP), preferably above 1360° C. A temperature of 1360° will lead to the formation of TetCP.

In a special embodiment of the invention a further step D1 is performed after steps A to C consisting of:

D) sintering said material obtained in step C with said pyrogene-free calcium phosphate at a temperature over 600° C. to form β-TCP.

The purpose of this additional step DI is the reduction of microporosity of the β-TCP blocks used initially, i.e. before step A and increase of the mechanical properties (see Example 2]

In an alternative embodiment a further step D2 is performed after steps A to C consisting of:

D2) sintering said material obtained in step C with said pyrogene-free calcium phosphate at a temperature over 600° C. to form another pyrogene-free calcium phosphate. Said pyrogene-free calcium phosphate obtained after step D2 is preferably beta-TCP.

The temperature of step D1 or D2 may be over 1000° C. and preferably in the range of 1100° C. to 1300° C.

Steps A to C may be repeated several times before effecting step D1 or D2.

Step C may also be repeated several times.

By the repetition it is possible to obtain one phase or one crystalline structure in the first stage, and another phase/crystalline structure in the second which results in a higher specific surface area.

The sintering of step D1 or D2 may be performed until a linear shrinkage of the end-product of at least 5%, preferably at least 10% is obtained.

The water or aqueous solution used in step C has purposefully a pH in the range of 2-13, preferably in the range of 2-10. Typically the pH-value is between 4 and 7. Said water or aqueous solution may additionally contain orthophosphate and calcium ions. This addition accelerates the transformation of alpha-TCP into an apatite, which is certainly an industrial advantage.

The end product obtained by the method according to the invention is obtained in nanometer-sized crystals. Said nanometer-sized crystals—by application of the Rietveld theory to x-ray diffraction patterns - are smaller than 100 nm, preferably smaller than 50 nm. Said crystals have a ratio between its longest and shortest dimension of less than 20, preferably less than 5. Said crystals have a maximum dimension of 10 microns, preferably of maximum 2 microns. Said crystals have a specific surface area (SSA) of more than 3 m²/g, preferably more than 10 m²/g. Said specific surface area (SSA) is at least 10 times, preferably at least 20 times larger than the SSA of said educts(s). Said apatite has macropores with a mean diameter in the range of 50 to 2000 microns, preferably in the range of 100 to 1000 microns.

Said end products may preferably be in the form of a porous scaffold with a permeability in the range of 10⁻⁶ to 10⁻¹² m², preferably in the range of 10⁻⁸ to 10⁻⁹ m². With this highly porous and interconnected structure a high permeability can be achieved. Said end products contain at most 2 weight-percent of organic compounds, preferably at most 0.2 weight percent. This avoids any problems with sterilization of the end product.

The pyrogene-free calcium phosphate obtained by the method according to the invention can be advantageously used as a bone fixation or bone replacement implant or as a surface layer for a bone fixation or bone replacement implant.

Several embodiments of the invention will be described in the following examples.

### EXAMPLE 1

Open-macroporous β-TCP cylinders (mean pore diameter of 0.5 mm; porosity of 73%; height 25 mm; diameter: 12 mm) were calcined at 1500° C. for one hour and then cooled down in the furnace at 5° C./min down to 100° C. The blocks consisted of pure α-TCP. Each of the samples was then placed in 10 mL 0.2M Na₂HPO₄ solution preheated 60° C. and incubated at 60° C. for 4 days, rinsed in ethanol, and then dried in air at 60 ° C. The samples consisted of pyrogene-free calcium-deficient hydroxyapatite [CDHA; Cag(HPO₄)₅OH] as shown by XRD analysis. The specific surface area (SSA) was 11 m²/g. The samples which had not been used for analysis (XRD, SSA) were then packaged twice and sterilized by gamma irradiation for further use.

### EXAMPLE 2

Open-macroporous β-TCP cylinders (mean macropore diameter of 0.5 mm; porosity of 73%; height 25 mm; diameter: 12 mm) were calcined at 1300 ° C. for one hour and then cooled down in the furnace at a rate of 10° C./min down to 100° C. The samples experienced a 2 % linear size decrease during this first thermal treatment. XRD analysis demonstrated that the samples consisted of α-TCP. The samples were then boiled in a 0.2M Na₂HPO₄ solution for 1 day, rinsed in ethanol, and then dried in air at 60° C. Afterwards, the samples were sintered at 1100° C. for 4 hours (heating and cooling rate: 2° C./min) to obtain β-TCP cylinders. The linear shrinkage during sintering amounted to 8%. The final macropore diameter was 0.45 mm, the porosity was 63% and the cylinders had a diameter and length of 22.5 and 10.8 mm, respectively. Through this volume change, the compressive strength of the β-TCP cylinder increased from 6 MPa to 12 MPa.

### EXAMPLE 3

100 g of an equimolar mixture of dicalcium phosphate [DCP; CaHPO₄], and hydroxyapatite (HA) [with a Ca/P molar ratio of the mixture of DCP and HA equal to 1.50], 5 g stearic acid and 100 g polymethylmethacrylate (PMMA) beads (0.3 mm in diameter) were sieved at a size of 0.5 mm with the help of 10 rubber cubes (1 cm in length). Then, the mixture was mixed end-over-end in a Turbula mixer for 10 minutes. Afterwards, the resulting mixture was placed into cylindrical polyurethane containers and pressed isostatically at a pressure of 100 MPa to obtain dense cylinders. These cylinders were ground and sieved to obtain granules in the size ranges of 0.050 to 0.125 mm, 0.125 to 0.5 mm, 0.5 to 0.7 mm, 0.7 to 1.4 mm and 1.4 to 2.8 mm in diameter. The different granule (shaped block) fractions were then slowly heated up to burn off the PMMA granules and finally sintered at 1400° C. (step A). The residual percentage of organic material after sintering of the PMMA was below the detection limit, i.e. <0.001%.

Forced cooling was performed at a rate of 5° C./min down to 100° C. (step B). At that temperature, the granule fractions were placed in 100 mL bottles containing a 0.02M H₂CO₃ solution (1 mL/g of granule; solution pre-heated at T=80° C.) and incubated for 2 days at 80° C. with the bottle cap closed (step C). The resulting granule fractions were washed twice in ethanol, and dried in their 100 mL bottles at 150° C. for 2 days (cap open). Finally, the bottles were closed, cooled down, and their contents were sampled (1, 5 and 10 cc samples) and packaged twice. Last but not least, sterilization was performed by gamma-sterilization.

### EXAMPLE 4

Open-macroporous β-TCP cylinders (mean macropore diameter of 0.2 mm; porosity of 80%; height 20 mm; diameter 10 mm) were calcined at 800° C. for 4 hours and then cooled down in the furnace down to 60° C. (these blocks contained less than 0.01% Mg and hence converted to α-TCP at a relatively low temperature). The cylinders were then incubated at 60° C. with a 1.0M phosphoric acid solution (320 mL solution for 100 g β-TCP) for 5 h, and then rinsed twice in warm (60° C.) deionized water, and then dried at 60° C. for 2 days. The samples consisted mainly of monetite (=CaHPO₄) with some traces of DCPD (Ca/P molar ratio of 1.0). Some samples were incubated in pH 6.0 and pH 8.0 phosphate buffered solution for 2 days to obtain either OCP or CDHA blocks, respectively.

### EXAMPLE 5

Spherical granules consisting of hydroxyapatite (Ca10(PO4)6(OH)2) (mean diameter of 0.25 mm; specific surface area: 1.2 m²/g) were calcined at 1450° C. for 4 hours in a zirconia plate and then cooled down in air down to roughly 300° C. (as measured with an infrared thermometer). The granules consisted of a mixture of α-TCP and tetracalcium phosphate (Ca4(PO4)2O) (molar ratio: 2:1). The plate containing the granules were then transferred into an autoclave at 80° C., and autoclaving was started (6 h at 120° C.). After the autoclaving cycle, drying was performed at 90° C. After these processing steps, the granules had a mean diameter of 0.22 mm and a specific surface area: 11 m²/g, and they consisted of hydroxyapatite.

While various descriptions of the present invention are described above, it should be understood that the various features can be used singly or in any combination thereof. The scope of the present invention is accordingly defined as set forth in the appended claims.

1: Method for producing essentially pyrogene-free calcium phosphate starting from one or more calcium phosphate educts having a Ca/P molar ratio in the range of 1.00 to 2.00 and being formed in a pre-determined shape which remains essentially the same during the following procedural steps:
A) transforming said educt(s) at least partly to beta-tricalcium phosphate (β-TCP), alpha-tricalcium phosphate (α-TCP), tetracalcium phosphate.(TetCP) or a mixture thereof at a temperature above 600° C.;
B) cooling down the material obtained in step A with said β-TCP, α-TCP, TetCP or a mixture thereof to below 600° C.;
C) reacting the material obtained in step B with said β-TCP, α-TCP, TetCP or a mixture thereof with water in gas or liquid phase or in an aqueous solution at a temperature above room temperature to obtain an end-product which is essentially pyrogene-free.

2: Method according to claim 1, wherein said temperature of step B is superior to room temperature.

3: Method according to claim 2, wherein said temperature of step B is superior to 50° C.

4: Method according to claim 1, wherein the temperature when starting with step C is brought above room temperature.

5: Method according to claim 4, wherein the temperature when starting with step C is brought above 50° C.

6: Method according to claim 1, wherein said temperature of step C is superior to 30° C.

7: Method according to claim 6, wherein said temperature of step C is superior to 50° C.

8: Method according to claim 1, wherein the intermediate products obtained in said step B are stored at a relative humidity of maximum 20%.

9: Method according to claim 1, wherein the β-TCP, α-TCP, TetCP or a mixture thereof obtained in step A is directly cooled down without prior mechanical treatment.

10: Method according to claim 1, wherein said pyrogene-free calcium phosphate has a content of endotoxin units (EU) lower than 1 EU/g.

11: Method according to claim 1, wherein step C is performed at a pressure larger than 1 atm.

12: Method according to claim 1, wherein said the end-product obtained in step C has a minimum content of pyrogene-free calcium phosphate of more than 20 weight-percent.

13: Method according to claim 1, wherein said reaction of step C is performed at a temperature above 80° C.

14: Method according to claim 1, wherein the aqueous solution of step C is diluted carbonic acid in order to obtain carbonated apatite.

15: Method according to claim 1, wherein the aqueous solution of step C is a sodium fluoride solution in order to obtain fluoroapatite.

16: Method according claim 1, wherein said educt(s) are shaped in the form of a granular or open-macroporous block.

17: Method according to claim 16, wherein the single granules of said granular block have a dimension larger than 50 microns.

18: Method according to claim 16, wherein the single granules of said granular block have a minimum apparent volume of 50,000 microns³.

19: Method according to claim 16, wherein the single granules of said granular block have a minimum weight of 0.04 micrograms.

20: Method according to claim 1, wherein said educts are pre-shaped by slip-casting, granulation techniques, emulsification, grinding, 3D printing or a combination thereof.

21: Method according to claim 1, wherein said educts are pre-shaped by pressing.

22: Method according to claim 1, wherein said calcium phosphate educts belong to the group of: Dicalcium phosphate [DCP; CaHPO₄], dicalcium phosphate dihydrate [DCPD; CaHPO₄2H₂O], calcium pyrophosphate [Ca₂P₂O₇], alpha-TCP, beta-tricalcium phosphate [β-TCP; Ca₃(PO₄)₂)], calcium-deficient hydroxyapatite [CDHA; Ca₉(HPO₄)₅OH], apatite, hydroxyapatite, amorphous calcium phosphate [ACP], octocalcium phosphate [Ca₈H₂(PO₄)₆.5H₂O] and tetracalcium phosphate.

23: Method according to claim 1, wherein said calcium phosphate educts contain one or more source of ions selected from the group consisting of C, Cl, F. Li, K, Mg Na, S, Si, and Sr.

24: Method according to claim 23, wherein said ions are present in an amount of less than 0.2 weight-%.

25: Method according to claim 1, wherein said water is bi-distilled and/or sterile water.

26: Method according to claim 1, wherein said gas phase has a relative humidity of at least 80%.

27: Method according to claim 26, wherein said gas phase has a relative humidity of 100%.

28: Method according to claim 1, wherein said water is essentially pyrogene-free.

29: Method according to claim 1, wherein the highest temperature achieved in step A is kept for at least 1 minute.

30: Method according to claim 1, wherein the cooling rate in step B is larger than 1° C./min.

31: Method according to claim 1, wherein the temperature in step B is lowered to less than 200° C.

32: Method according to claim 1, wherein said educt(s) have a Ca/P molar ratio higher than 1.35.

33: Method according to claim 1, wherein said educt(s) have a Ca/P molar ratio lower than 1.70.

34: Method according to claim 1, wherein said end-product has a Ca/P molar ratio higher than 1.0.

35: Method according to claim 1, wherein said end-product has a Ca/P molar ratio lower than 2.0.

36: Method according to claim 1, wherein said end-product has a Ca/P molar ratio between 1.45 and 1.53.

37: Method according to claim 1, wherein the temperature of step A is above 700° C.

38: Method according to claim 37, wherein the temperature of step A is above 900° C.

39: Method according to claim 38, wherein the temperature of step A is above 1120° C.

40: Method according to claim 1, wherein the educts(s) are at least partly transformed to alpha-TCP during step A.

41: Method according to claim 1, wherein a further step D1 is performed after steps A to C consisting of: D1) sintering said material obtained in step C with said pyrogene-free calcium phosphate at a temperature over 600° C. to form β-TCP.

42: Method according to claim 1, wherein a further step D2 is performed after steps A to C consisting of: D2) sintering said material obtained in step C with said pyrogene-free calcium phosphate at a temperature over 600° C. to form another pyrogene-free calcium phosphate.

43: Method according to claim 42, wherein said pyrogene-free calcium phosphate obtained after step D2 is beta-TCP.

44: Method according to claim 41, wherein the temperature of step D1 is over 1000° C.

45: Method according to claim 41, wherein steps A to C are repeated several times before effecting step D1.

46: Method according to claim 1, wherein step C is repeated several times.

47: Method according to 41, wherein the sintering of step D1 is performed until a linear shrinkage of said end-product of at least 5%.

48: Method according to claim 1, wherein said water or aqueous solution used in step C has a pH in the range of 2-13.

49: Method according to claim 1, wherein said water or aqueous solution contains orthophosphate and calcium ions.

50: Method according to claim 1, wherein said end-product contains, OCP.

51: Method according to claim 1, wherein said end-product contains an apatite.

52: Method according to claim 1, wherein said end-product contains DCP.

53: Method according to claim 1, wherein said end-product contains DCPD.

54: Method according to claim 50, wherein said end-product contains a mixture of OCP and/or apatite and/or DCP and/or DCPD.

55: Pyrogene-free calcium phosphate obtained by the method according to claim 1, wherein said apatite is obtained in nanometer-sized crystals.

56: Pyrogene-free calcium phosphate according to claim 55, wherein said nanometer-sized crystals—by application of the Rietveld theory to x-ray diffraction patterns—are smaller than 100 nm.

57: Pyrogene-free calcium phosphate according to claim 55, wherein said crystals have a ratio between its longest and shortest dimension of less than 20.

58: Pyrogene-free calcium phosphate according to claim 55, wherein said crystals have a maximum dimension of 10 microns.

59: Pyrogene-free calcium phosphate according to claim 55, wherein said crystals have a specific surface area (SSA) of more than 3 m²/g.

60: Pyrogene-free calcium phosphate according to claim 55, wherein said specific surface area (SSA) is at least 10 times, larger than the SSA of said educts(s).

61: Pyrogene-free calcium phosphate according to claim 55, wherein said calcium phosphate has macropores with a mean diameter in the range of 50 to 2000 microns.

62: Pyrogene-free calcium phosphate according to claim 55, wherein said calcium phosphate is in the form of a porous scaffold with a permeability in the range of 10⁻⁶ to 10⁻¹² m².

63: Pyrogene-free calcium phosphate according to claim 55, wherein said calcium phosphate contains at most 2 weight-percent of organic compounds.

64: Use of the pyrogene-free calcium phosphate according to claim 55, for the manufacture of a bone fixation or bone replacement implant or as a surface layer for a bone fixation or bone replacement implant.
